(19) United States
(12) Patent Application Publication
(10) Pub. No.: US 2005/0247807 A1
(43) Pub. Date: Nov. 10, 2005

(54) System for automatically recycling flat glass from workpiece and method of the same

(76) Inventors: Wen-Ben Liu, Taipei City (TW); Pai-Shan Pa, Shinjuang City (TW); Su-Zen Chiu, Shinjuang City (TW)

Correspondence Address: Hoffman, Warnick & D' Alessandro LLC, Three E-Comm Square, Albany, NY, 12207, US

(21) Appl. No.: 11/079,578

(22) Filed: Mar. 14, 2005

(30) Foreign Application Priority Data
Mar. 15, 2004 (TW) 093203898

(51) Int. Cl. B02C 7/00

(52) U.S. Cl. 241/24.3

(57) ABSTRACT

A system and the method thereof are used for automatically recycling a flat glass from a workpiece. The system includes a first stripper, a second stripper, at least one loader, a residue-removing device, a clean device, and an excimer device. The first stripper is used for removing a metal thin film from the workpiece when the workpiece is transported to the first stripper by the at least one loader. The second stripper is used for removing an organic thin film from the workpiece when the workpiece is transported to the second stripper by the at least one loader. The residue-removing device has a brush for removing the residues from the workpiece. The clean device is used for rinsing and drying the workpiece. The excimer device is used for removing a smooth thin film from the workpiece to obtain the flat glass.

### BACKGROUND OF THE INVENTION

1. Field of the Invention

The present invention relates to a system and the method thereof for automatically recycling a flat glass from a workpiece comprising the flat glass, and more particularly to a system and the method for removing defects from the workpiece and reducing some contamination (e.g. organic or metal), generated by the workpiece, through a chemical reaction device or a metal filter.

2. Description of the Prior Art

Color filters are widely used for liquid crystal color display devices and produced by art-known methods, for example a printing method, a dying method, a pigment dispersing method, an electrodeposition method, a resist electrodeposition method and the like. It is generally desired that they have no defective picture elements thereof. It is, however, very difficult to produce a color filter having no picture element defects which are caused by small dust being present in surrounding production facilities or due to pinholes or foreign articles brought about by insufficient cleaning of substrates.

In order to increase yield rate in production of the color filters, some methods of correcting the defects in the color filters or lack of the picture elements have been proposed. For example, it is proposed that a colored photosensitive resin paint be coated on the defects. In this method, however, it is very difficult to make the surface of the corrected portion smooth, because the coating process has technical limits. A method is also proposed in which photosensitive resin paint solution is poured on the color filter having defects and the remaining solution on the normal portion is removed and then cured. It is, however, difficult to completely remove the paint solution on the undefective portion, which causes so-called scumming. Further, in the above two methods, if there are defects in plural color portions of the color layer, the steps of coating a photosensitive resin paint solution, exposing and developing are repeated plural times and therefore the repetition of the steps is time-consuming and troublesome. It may also give rise to other defects. Furthermore, the prior art also proposes a modification of the above method wherein a protective layer is formed on the normal portion in the color layer before pouring the photosensitive resin paint solution on the color layer to avoid scumming, but the other problems still remain even in the modified process.

Therefore, the present invention provides a system and the method for automatically recycling a flat glass from a workpiece comprising the flat glass to solve the above-mentioned problems.

### SUMMARY OF THE INVENTION

The objective of the present invention is to provide a system and the method for automatically recycling a flat glass from a workpiece comprising the flat glass, and more particularly the present invention utilizes two strippers to respectively remove a metal thin film and an organic thin film from the workpiece.

In an embodiment according to the present invention, the system, used for automatically recycling a flat glass from a workpiece including the flat glass, includes a first stripper, a second stripper, a first loader, a second loader, a residue-removing device, a clean device, and an excimer device.

The first loader is connected to the first stripper for transporting the workpiece to the first stripper. The first stripper is used for removing a metal thin film from the workpiece when the workpiece is transported to the first stripper by the first loader. The second loader is connected to the second stripper for transporting the workpiece to the second stripper. The second stripper is used for removing an organic thin film from the workpiece when the workpiece is transported to the second stripper by the second loader. The residue-removing device is respectively connected to the first stripper and the second stripper and has a brush for removing the residues from the workpiece. The clean device is connected to the residue-removing device and used for rinsing and drying the workpiece. The excimer device is connected to the clean device and used for removing a smooth thin film from the workpiece to obtain the flat glass.

Therefore, the present invention utilizes two strippers to respectively remove different thin films from the workpiece, so as to prevent the workpiece from secondary pollution. The present invention also utilizes the residue-removing device instead of manual operation to automatically remove the residues from the workpiece, so as to effectively improve the quality of the recycled flat glass. Moreover, the present invention utilizes the excimer device to remove the smooth thin film, such that the surface of the recycled flat glass can obtain a better hydrophilic quality.

The advantage and spirit of the invention may be understood by the following recitations together with the appended drawings.

### BRIEF DESCRIPTION OF THE APPENDED DRAWINGS

FIG. 1 is a functional block diagram of a recycling system according to an embodiment of the present invention.

FIG. 2 is a functional block diagram of a recycling system according to another embodiment of the present invention.

FIG. 3 is a flowchart of the method of removing a metal thin film according to the present invention.

FIG. 4 is a flowchart of the method of removing an organic thin film according to the present invention.

### DETAILED DESCRIPTION OF THE INVENTION

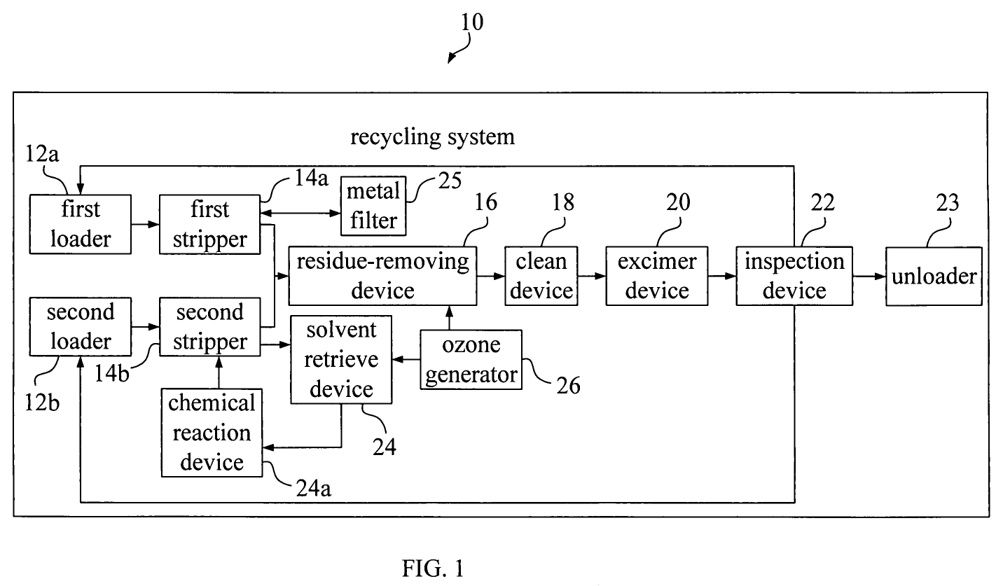

Referring to FIG. 1, FIG. 1 is a functional block diagram of a recycling system 10 according to an embodiment of the present invention. The system 10 is used for automatically recycling a flat glass (not shown) from a workpiece (not shown) including the flat glass. The workpiece is a semi-product of a color filter or the like. In this embodiment, the system 10 includes a first loader 12a, a second loader 12b, a first stripper 14a, a second stripper 14b, a residue-removing device 16, a clean device 18, and an excimer device 20. The first loader 12a is connected to the first stripper 14a and used for transporting the workpiece to the first stripper 14a. The first stripper 14a is used for removing a metal thin film from the workpiece when the workpiece is transported to the first stripper 14a by the first loader 12a. The second loader 12b is connected to the second stripper 14b and used for transporting the workpiece to the second stripper 14b. The second stripper 14b is used for removing an organic thin film from the workpiece when the workpiece is transported to the second stripper 14b by the second loader 12b. The first loader 12a and the second loader 12b both have a plurality of rolling wheels (not shown) and a clamp (not shown) for transporting the workpiece. The first stripper 14a has a belt transmission mechanism (not shown) with a plurality of embedded recesses for removing the metal thin film from the workpiece inch by inch. The second stripper 14b also has a belt transmission mechanism (not shown) with a plurality of embedded recesses for removing the organic thin film from the workpiece inch by inch. The residue-removing device 16 is respectively connected to the first stripper 14a and the second stripper 14b and has a brush (not shown) for removing the residues from the workpiece. The clean device 18 is connected to the residue-removing device 16 and used for rinsing and drying the workpiece. The excimer device 20 is connected to the clean device 18 and used for removing a smooth thin film from the workpiece to obtain the flat glass. In other words, no matter what kind of thin film a workpiece, desired to be recycled, has thereon, the present invention can remove the thin film (including metal thin film or organic thin film) from the workpiece via the corresponding stripper, so as to prevent the workpiece from secondary pollution.

As shown in FIG. 1, the system 10 further includes an inspection device 22 and an unloader 23. The inspection device 22 is connected to the excimer device 20 and used for inspecting a quality of the flat glass. The unloader 23 is connected to the inspection device 22. According to the inspected quality of the flat glass, the inspection device 22 will selectively transport the flat glass renewedly as the workpiece back to the first loader 12a or the second loader 12b. In other words, when the quality of the recycled flat glass is not good enough to be used, the inspection device 22 will transport the recycled flat glass back to the first loader 12a or the second loader 12b to be processed again, so as to obtain the recycled flat glass with better quality. When the quality of the recycled flat glass is good enough to be used, the inspection device 22 will transport the recycled flat glass to the unloader 23.

As shown in FIG. 1, the system 10 further includes a solvent retrieve device 24, a chemical reaction device 24a, and an ozone generator 26. The solvent retrieve device 24 is connected to the second stripper 14b and used for retrieving an organic solvent from the second stripper 14b. The chemical reaction device 24a is connected to the solvent retrieve device 24 and used for separating a chemical liquid from the organic solvent for reuse. The ozone generator 26 is connected to the solvent retrieve device 24 and used for generating ozone to the solvent retrieve device 24 to separate the organic solvent into water and carbon monoxide/dioxide. Accordingly, the solvent generated during the recycling process can be decomposed completely without resulting in any pollution, and the chemical liquid can be reused.

As shown in FIG. 1, the system 10 further includes a metal filter 25. The metal filter 25 is connected to the first stripper 14a and used for separating a chemical liquid from a metal chemistry for reuse.

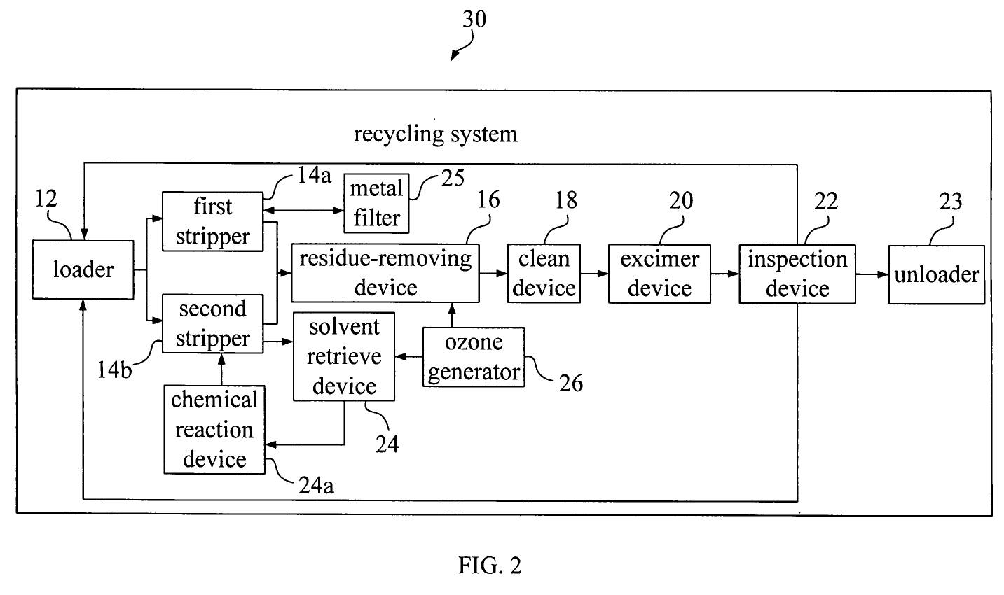

Referring to FIG. 2, FIG. 2 is a functional block diagram of a recycling system 30 according to another embodiment of the present invention. The main difference between the system 30 and the system 10 is that the system 30 comprises only one loader 12, such that the loader 12 is respectively connected to the first stripper and the second stripper and used for alternatively transporting the workpiece to the first stripper or the second stripper. The principle of the system 30 shown in FIG. 2 is the same as the system 10 shown in FIG. 1, and it won't be described again.

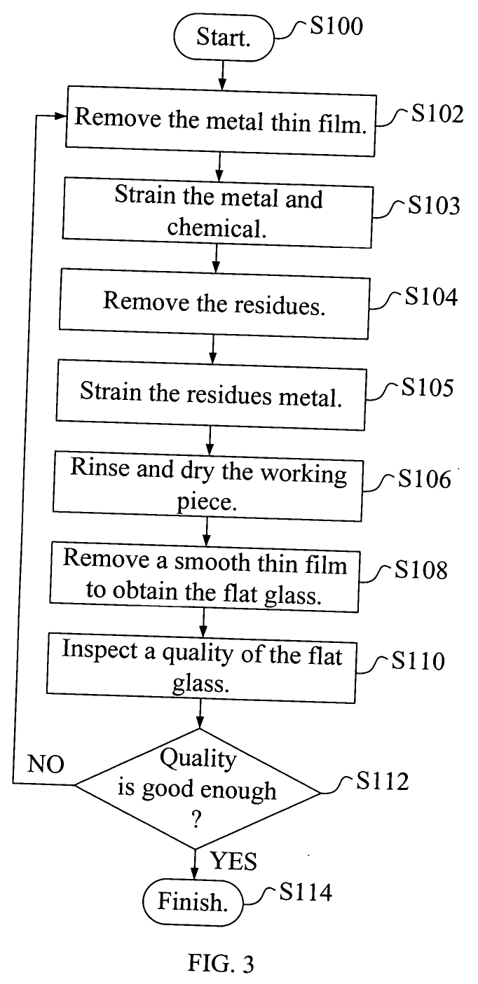

Referring to FIG. 3, FIG. 3 is a flowchart of the method of removing a metal thin film according to the present invention. The present invention also provides a method for automatically recycling a flat glass from a workpiece including the flat glass. The workpiece has a metal thin film thereon. The method includes the following steps:
S100: Start.
S102: Remove the metal thin film from the workpiece.
S103: Strain the metal and chemical from the metal blended chemical liquid.
S104: Remove the residues from the workpiece.
S105: Strain the residues metal from the metal blended chemical liquid.
S106: Rinse and dry the workpiece.
S108: Remove a smooth thin film from the workpiece to obtain the flat glass.
S110: Inspect a quality of the flat glass.
S112: Determine whether the quality is good enough. If it is a NO, transport the flat glass renewedly as the workpiece back to repeat the steps S102 through S110, otherwise go to step
S114.
S114: Finish.

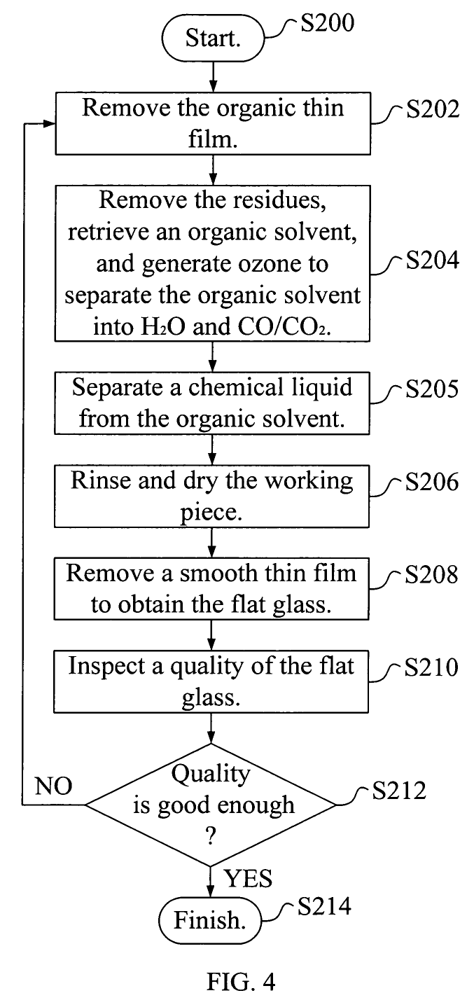

Referring to FIG. 4, FIG. 4 is a flowchart of the method of removing an organic thin film according to the present invention. The present invention also provides a method for automatically recycling a flat glass from a workpiece including the flat glass. The workpiece has an organic thin film thereon. The method includes the following steps:
S200: Start.
S202: Remove the organic thin film from the workpiece.
S204: Remove the residues from the workpiece, retrieve an organic solvent, and generate ozone to separate the organic solvent into water and carbon monoxide/dioxide.
S205: Separate a chemical liquid from the organic solvent for reuse.
S206: Rinse and dry the workpiece.
S208: Remove a smooth thin film from the workpiece to obtain the flat glass.
S210: Inspect a quality of the flat glass.
S212: Determine whether the quality is good enough. If it is a NO, transport the flat glass renewedly as the workpiece back to repeat the steps S202 through S210, otherwise go to step S214.
S214: Finish.

Compared to the prior art, the present invention utilizes two strippers to respectively remove different thin films from the workpiece, and the present invention can reduce not only metal contamination but also oxide solvent contamination, so as to prevent the workpiece from secondary pollution. The present invention also utilizes the residue-removing device instead of manual operation to automatically remove the residues from the workpiece, so as to effectively improve the quality of the recycled flat glass. Furthermore, the present invention utilizes the excimer device to remove the smooth thin film, such that the surface of the recycled flat glass can obtain a better hydrophilic quality. Moreover, the solvent generated during the recycling process can be decomposed completely without resulting in any pollution.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A system for automatically recycling a flat glass from a workpiece comprising the flat glass, said system comprising:
a first stripper for removing a metal thin film from the workpiece when the workpiece is transported to the first stripper;
a second stripper for removing an organic thin film from the workpiece when the workpiece is transported to the second stripper;
at least one loader, which each respectively connected to the first stripper and the second stripper, for alternatively transporting the workpiece to the first stripper or the second stripper;
a residue-removing device, respectively connected to the first stripper and the second stripper, having a brush for removing the residues from the workpiece;
a clean device, connected to the residue-removing device, for rinsing and drying the workpiece; and
an excimer device, connected to the clean device, for removing a smooth thin film from the workpiece to obtain the flat glass.

2. The system of claim 1, further comprising an inspection device, connected to the excimer device, for inspecting a quality of the flat glass and selectively transporting the flat glass renewedly as the workpiece back to the loader according to the inspected quality of the flat glass.

3. The system of claim 2, further comprising an unloader, connected to the inspection device, for receiving the flat glass being completely recycled.

4. The system of claim 1, wherein the workpiece is a semi-product of a color filter.

5. The system of claim 1, wherein each of the at least one loader comprises a plurality of rolling wheels and a clamp for transporting the workpiece.

6. The system of claim 1, wherein the first stripper has a belt transmission mechanism with a plurality of embedded recesses for removing the metal thin film from the workpiece inch by inch.

7. The system of claim 1, wherein the second stripper has a belt transmission mechanism with a plurality of embedded recesses for removing the organic thin film from the workpiece inch by inch.

8. The system of claim 1, further comprising a solvent retrieve device, connected to the second stripper, for retrieving an organic solvent from the second stripper.

9. The system of claim 8, further comprising a chemical reaction device, connected to the solvent retrieve device, for separating a chemical liquid from the organic solvent for reuse.

10. The system of claim 8, further comprising an ozone generator for generating ozone to the solvent retrieve device to separate the organic solvent into water and carbon monoxide/dioxide.

11. The system of claim 1, further comprising a metal filter, connected to the first stripper, for separating a chemical liquid from a metal chemistry for reuse.

12. A method for automatically recycling a flat glass from a workpiece comprising the flat glass, said method comprising the steps of:
(a) removing a thin film from the workpiece;
(b) removing the residues from the workpiece;
(c) rinsing and drying the workpiece;
(d) removing a smooth thin film from the workpiece to obtain the flat glass;

13. The method of claim 12, further comprising the step of:
(e) inspecting a quality of the flat glass and selectively transporting the flat glass renewedly as the workpiece back to repeat the steps (a) through (d) according to the quality of the flat glass.

14. The method of claim 12, wherein the workpiece is a semi-product of a color filter.

15. The method of claim 12, wherein the thin film is a metal thin film.

16. The method of claim 12, wherein the thin film is an organic thin film.

17. The method of claim 16, wherein the step (b) further comprises the steps of:
(b1) retrieving an organic solvent after the organic thin film is removed from the workpiece; and
(b2) generating ozone to separate the organic solvent into water and carbon monoxide/dioxide.
(b3) separating a chemical liquid from the organic solvent for reuse.

16. The method of claim 15, wherein the step (b) further comprises the steps of:
(b1) separating a chemical liquid from a metal chemistry for reuse after the metal thin film is removed from the workpiece.
